(19) United States
(12) Patent Application Publication
(10) Pub. No.: US 2024/0008425 A1
(43) Pub. Date: Jan. 11, 2024

(54) MOBILE ROBOT AND ROBOTIC FARMING SYSTEM

(71) Applicant: Nimble Robotics, Inc., San Francisco, CA (US)

(72) Inventor: Simon Kalouche, San Francisco, CA (US)

(73) Assignee: Nimble Robotics, Inc., San Francisco, CA (US)

(21) Appl. No.: 18/039,550

(22) PCT Filed: Dec. 3, 2021
(86) PCT No.: PCT/US2021/061723

§ 371 Date: May 31, 2023

Related U.S. Application Data
(60) Provisional application No. 63/161,193, filed on Mar. 15, 2021.
(60) Provisional application No. 63/121,375, filed on Dec. 4, 2020.

(51) Int. Cl. A01G 9/26; B25J 5/00; B65G 1/04; B25J 15/00; A01G 3/02; A01G 9/02

(52) U.S. Cl. CPC A01G 9/26; B25J 5/007; B65G 1/0464; B25J 15/0019; A01G 3/02; A01G 9/025; A01G 9/027; A01G 2009/003

(57) ABSTRACT

A robotic farming system includes a storage structure and a mobile robot. The storage structure has a set of parallel rails and is configured to accommodate crops in a plurality of horizontal rows arranged in a vertical direction. The robot includes a body, a mobility assembly to move the body along the set of parallel rails and a service effector for servicing the crops. The service effector may be provided on a plate that is extendable in a vertical direction relative to the body for servicing the crops accommodated within the storage structure. In one aspect, the service effector includes one or more nozzles for spraying fluid such as water, a gas or growth media on the crops. Alternatively, the service effector may be a manipulator and/or pruning tool.

### CROSS-REFERENCE TO RELATED APPLICATIONS

The present application claims the benefit of the filing of U.S. Provisional Patent Application No. 63/121,375, filed Dec. 4, 2020, and U.S. Provisional Patent Application No. 63/161,193, filed Mar. 15, 2021, the disclosures of which are hereby incorporated herein by reference.

### BACKGROUND

The present disclosure relates to vertical farming, and more particularly, to robotic systems for cultivating and harvesting crops.

Outdoor farming generally requires a large area of land and cooperative environmental conditions. That is, a successful harvest is dependent, at least in part, upon the weather. On the other hand, indoor vertical farming offers several advantages over outdoor farming including increased space efficiency and the ability to precisely control environmental conditions.

In conventional vertical farming systems, crops are grown in trays containing growth media. The trays are arranged in horizontal arrays and conveniently stacked in vertical layers on either side of a passageway, which provides access for an operator to service and/or harvest the crops. It is well understood, however, that the passageways reduce the farming density of the system. In other words, the amount of space used for growing the crops (e.g., the trays) is relatively small compared to the space required for the vertical farm as a whole. As indoor farming space is often scarce and expensive, alternative systems that maximize farming density are desired.

In one alternative approach, which offers a significant improvement in farming density, crops are grown within containers which are stacked on top of one another and arranged in adjacent rows. That is, no passageway for an operator is provided between adjacent rows of stacked containers. Thus, more crops can be farmed in a given space.

Various methods for cultivating crops within stacked containers have been contemplated. U.S. Pat. Pub. Nos. 2018/0035625 and 2019/0241362, for example, disclose systems in which containers are stacked in a plurality of rows within a frame and underneath a grid. The containers include servicing means which provide water, nutrients and light to the crops housed within the containers. A plurality of load handling devices, each of which are equipped with a lifting apparatus, navigate the grid and rearrange or retrieve the containers as needed.

Despite the increased farming density provided by the known stacked systems, various shortcoming remain. For example, the containers are expensive to manufacture due to their built-in servicing means. A typical stacked farming system can include thousands, if not tens-of-thousands of containers and, as a result, the upfront set-up cost of the known system can be prohibitively expensive. Moreover, while the load handling devices of the prior art are capable of rearranging the containers during crop cultivation, the load handling devices do not have the ability to directly service the crops to promote growth or the ability to inspect or harvest the crops once they are mature. As a result, servicing and harvesting the crops remain lengthy and labor intensive processes.

### BRIEF SUMMARY OF THE DISCLOSURE

A robotic farming system for cultivating and harvesting crops is provided herein. Among other advantages, the crops are arranged on or within low-cost stackable containers that are organized within a storage structure to form a high density vertical farm. The farming system includes a plurality of mobile robots configured to traverse the storage structure to service, cultivate and/or harvest the crops which significantly reduces these labor intensive processes and diminishes the overall cost of the system by eliminating large portions of the plumbing, lighting and servicing means required with respect to the prior art.

In accordance with a first aspect of the disclosure, a mobile robot for cultivating crops secured to or within a container is provided. The mobile robot includes a body, a wheel assembly having a plurality of wheels and an actuator configured to move the body along a set of parallel rails, and a plate extendable in a vertical direction relative to the body. The plate having a service effector for servicing the crops.

In accordance with another aspect of the disclosure, a robotic farming system includes a storage structure and a mobile robot. The storage structure includes a first set of parallel rails and is configured to accommodate crops in a plurality of horizontal rows arranged in a vertical direction. The mobile robot includes a body, a mobility assembly to move the body along the first set of parallel rails, and a service effector for servicing the crops.

### BRIEF DESCRIPTION OF THE DRAWINGS

FIG. 1 is a schematic illustration of a robotic farming system including a storage structure configured to house a plurality of containers accommodating crops and a plurality of robots disposed on the storage structure according to an embodiment of the present disclosure.

FIG. 2A is a schematic perspective view of the storage structure of FIG. 1.

FIG. 2B is an enlarged plan view of a portion of the storage structure of FIG. 2A illustrating rails of the storage structure.

FIG. 3A is perspective view of one of the rails of FIG. 2B and further depicts a fluid supply line and a valve within the rail.

FIG. 3B is an enlarged perspective view of a portion of the rail of FIG. 3A.

FIG. 4 is a cross section of the rail of FIG. 3B taken along line B-B.

FIG. 5 is a partial schematic perspective view of a mobile robot including an extendable plate with a service effector and a coupler installed on the storage structure of FIG. 2A accommodating containers of crops according to an embodiment of the present invention.

FIG. 6 is a partial schematic perspective view of two mobile robots installed on the storage structure of FIG. 2A accommodating containers of crops according to another embodiment of the present invention.

FIG. 7A is a cross-section view of the coupler of FIG. 5.

FIG. 7B is a partial perspective view of the storage structure of FIG. 2A illustrating a series of valves disposed along a length of a vertical member.

FIG. 8 is a partial perspective view of a modified storage structure including a gantry frame supporting an extendable plate having a service effector.

FIG. 9 is a schematic illustration of another modified storage structure including an assembly positioned above the storage structure and fluid supply lines extending from the assembly toward the storage structure.

### DETAILED DESCRIPTION

When terms of orientation, for example, “vertical” and “horizontal” or relative terms such as, “above,” “upwards,” “beneath,” “downwards” and the like are used herein to describe the orientation or relative position of specific features of the storage structure or of the mobile robot, the terms refer to the orientation or the relative position of the features in the normal gravitational frame of reference when the storage structure is positioned with a bottom of the storage structure resting on a ground surface. Also, as used herein, the terms “substantially,” “generally,” and “about” are intended to mean that slight deviations from absolute are included within the scope of the term so modified.

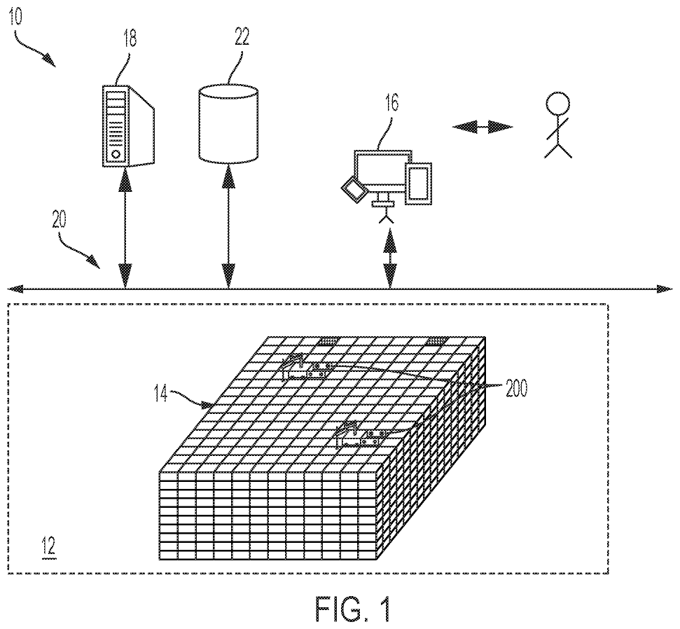

FIG. 1 is a schematic illustration of a robotic farming system 10 according to an embodiment of the present disclosure. One or more mobile robots 200 (sometimes referred to simply as the “robot(s)”) may be housed in an indoor vertical system (IVS) 12 and tasked with servicing crops accommodated within a storage structure 14. The term “service” means the performance of any farming task that at least in part assists in the cultivation (e.g., growth), control, maintenance and/or harvesting of a crop. A service may include without limitation delivering water, fertilizer, seeds, nutrients (via aeroponics, aquaponics or hydroponics), light, or a gas to the crops; pollinating the crops; or cutting, pruning, or otherwise manipulating the crop and/or its environment to control, maintain or promote growth of the crop. Robot 200 may operate in one of two modes: an autonomous mode, by executing autonomous control instructions, or a tele-operated mode, in which the control instructions are manually piloted by an operator. In one embodiment, mobile robot 200 may be a machine learning robot capable of executing autonomous and piloted control instructions.

Robotic farming system 10 may include one or more operator interfaces 16, one or more processor-based computer systems 18, each of which may be communicatively coupled via one or more network or non-network communication channels 20, and one or more storage devices 22. As used herein, the term “remote” means that the component is located apart from the referenced hardware. For example, the terms “remote processor” or “remote computer” refer to a processor in communication with and located apart from the referenced hardware component (such as the robot) and may include one or more processors or a single central processor for coordinating and automating the farming tasks between the multiple robots 200 within the robotic farming system 10. On the other hand, the term “onboard,” means that the component is being carried by the referenced hardware. For example, an “onboard processor” means that the processor is located within the referenced hardware (such as the robot). When the general term “processor” or “computer” is used, the term may refer to any remote processor, any on-board processor or a combination of the same, unless explicitly indicated otherwise.

Operator interface 16 includes one or more input devices to capture control instructions from an operator and one or more output devices. Operator interface 16 can therefore be used to observe aspects of the crops and/or of mobile robot 200 to analyze the crops and/or to assist the robot in performing farming tasks such as servicing and/or harvesting the crops. Thus, if robot 200 is unsuccessful at autonomously performing a farming task, the operator can utilize operator interface 16 to instruct the robot to complete the task in a particular manner. For example, the operator may instruct the robot to spray fluid at a specific location and/or orientation to reach the roots of a crop hidden behind an adjacent crop or to prune a crop to promote growth.

Computer system 18 tracks and coordinates the operation of robotic farming system 10. Each one of the robots 200 include an interface to send and/or receive processor readable data or processor executable instructions to computer 18 via communication channels 20. In this manner, computer 18 can send control instructions to robot 200 to execute a particular farming task such as pruning the crop. If the control instructions are unsuccessful in performing the farming task, or if the computer determines that the control instructions are unlikely to be successful, the system can automatically request intervention from an operator, thereby allowing robot 200 to be teleoperatively controlled by an operator. In this regard, a teleoperator can remotely pilot robot 200 and instruct the robot to position the service effector (in this example a pruning tool) into a sequence of poses (e.g., position and/or orientation and/or posture) to train a machine learning system to more accurately predict future autonomous control instructions and successfully perform that task.

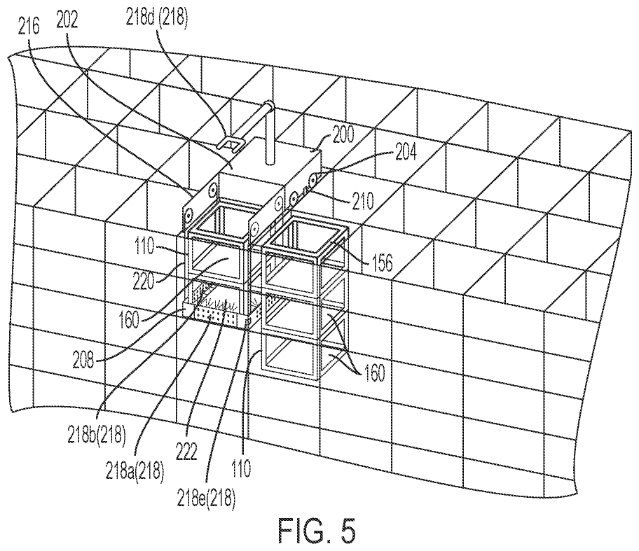

Storage structure 14 is configured to accommodate crop containers in any multi-layered (e.g., vertical) arrangement. As used herein, the term “container” means an object configured to house a crop within the container or to directly or indirectly secure the crop to an external or internal surface such as a wall, plane, or other medium, of the container. Container 110 may be, for example, a bin configured to accommodate a crop within the bin (shown in FIG. 5) or a wall-like structure configured to secure a crop to a surface of the structure (shown in FIG. 6). When it is necessary to distinguish between the foregoing types of containers, the term “bin” will be used to reference the container illustrated in FIG. 5 and the term “growing wall” or “growing wall component” will be used to reference the container illustrated in FIG. 6.

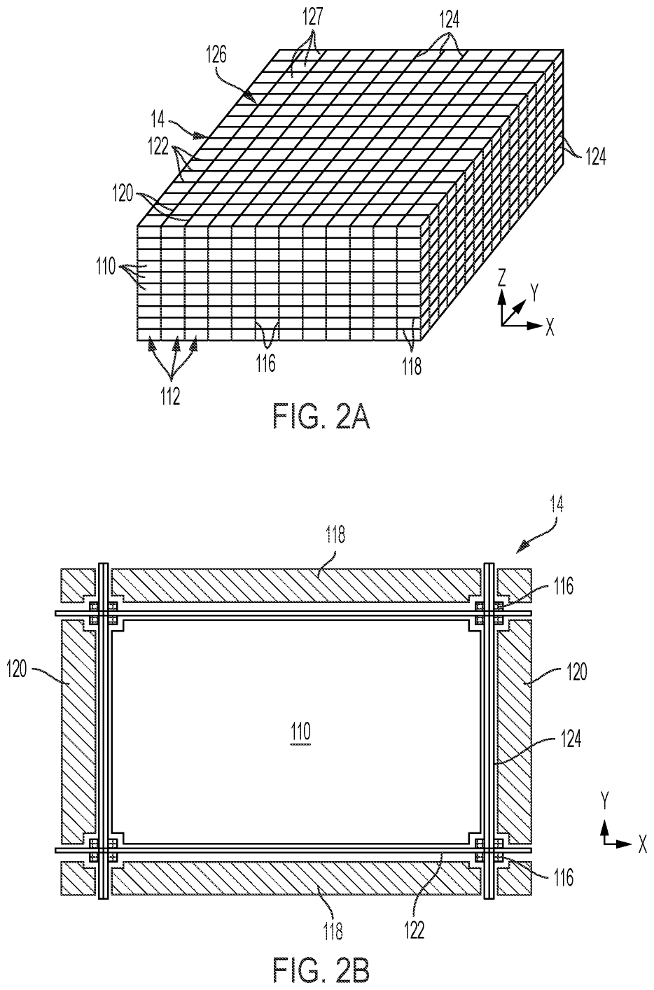

Turning now to FIGS. 2A and 2B, storage structure 14 is designed to efficiently store crop containers 110 in vertical stacks 112. Each container 110 is configured to hold one or more crops which may be the same species, or different species. Example crops may include food crops, feed crops, fiber crops, oil crops, ornamental crops or industrial crops. The crops may be arranged within storage structure 14 in a number of ways that optimize servicing and/or harvesting of the crops. For example, the crops may be arranged by species or preferred environment conditions (e.g., temperature and/or humidity) for the purpose of facilitating efficient servicing schedules; or by size/shape of the crops or harvesting cycles for efficient harvesting. In some situations, storage structure 14 may be constructed to include one or more isolated and insulated areas to maintain preferred environmental conditions based upon each species of crop.

Storage structure 14 includes vertical members 116 that form a plurality of vertical shafts for housing stacks 112. The vertical shafts are constructed to guard against substantial lateral movement of the stacked containers 110. In certain embodiments, storage structure 14 may further include a first set of horizontal support members 118 extending in a first direction (e.g., the X-direction) and a second set of horizontal support members 120 extending in a second direction (e.g., the Y-direction). Any one of vertical members 116, horizontal members 118 or horizontal members 120 may optionally include utilities to service the crops such as lights (LEDs, fluorescent lights, etc.); electrical circuitry; nutrient and/or water supply systems such as various aeroponic, hydroponic, and aquaponic systems; gas supply systems; and/or other environmental control systems including temperature regulators, heaters, humidity regulators, air regulators, fluid/gas flow regulators, air conditioners, or HVAC units any and/or all of which can be controlled by remote processor 18 to artificially regulate the climate within IVS 12. Vertical members 116, horizontal members 118, horizontal members 120, and/or the surfaces of the containers 110 themselves may additionally include mirrored paneling, or other reflective materials to redistribute light from a light source to the crops. In some instances, the foregoing utilities may be powered by solar panels provided on or around IVS 12 or by sun light entering the IVS through a glass ceiling, glass walls and/or windows.

The uppermost level of storage structure 14 includes a first set of rails 122 extending in the first direction (e.g., X-direction) and/or a second set of rails 124 extending in the second direction (e.g., Y-direction). In aspects in which storage structure 14 includes the first set of rails 122 and the second set of rails 124, the combination of the first and second set of rails forms a horizontally oriented grid 126 having a plurality of grid spaces 127. Rails 122 and/or rails 124 support robot(s) 200 and allow the robot(s) to move about the grid 126 above the stacks 112 of containers 110 in both the X-direction and the Y-direction.

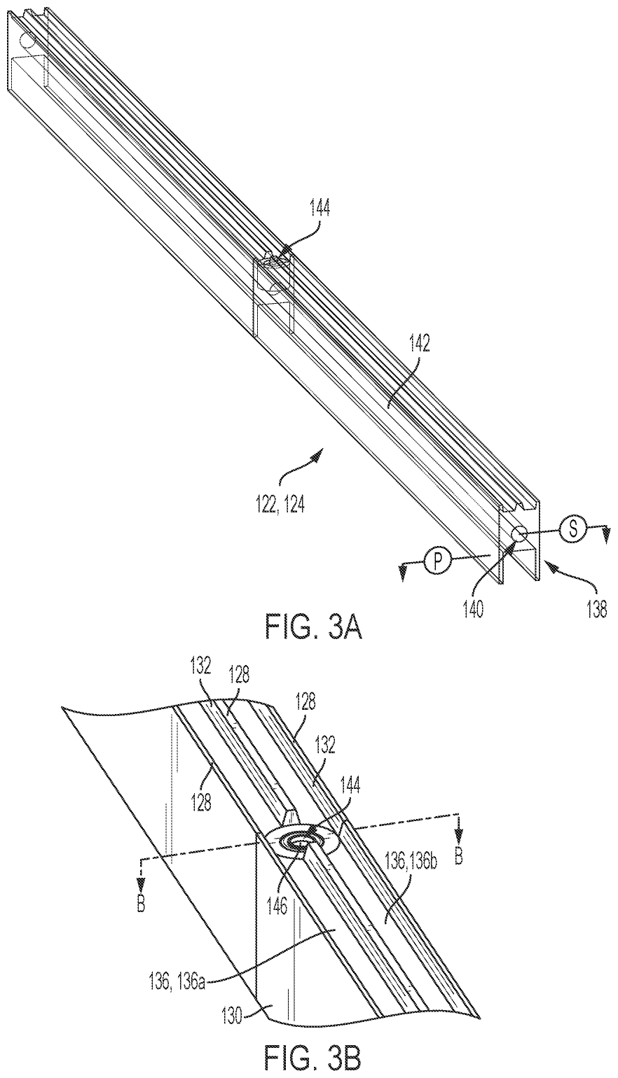

Referring to FIGS. 3A and 3B, each one of the rails 122, 124 forming grid 126 may be extruded or otherwise formed from a highly conductive metal such as aluminum. A power source P may be coupled to grid 126 to supply a voltage to rails 122, 124 and, in turn, to robots 200 for recharging onboard batteries or super/ultra-capacitors of the robot and/or for directly powering the various drive mechanisms of the robot. The power may be transferred from grid 126 to robots 200 in one of several methods. For example, grid 126 may have a single polarity such as a negative charge, while a structure above the grid (not shown) is positively charged (or vice versa). Robots 200 may include an antenna which contacts the positively charged structure above grid 126 and completes the circuit between the opposite polarities. Alternatively, adjacent rails of one set of the parallel rails 122, 124 may have opposite polarities such that when robot 200 is disposed on the adjacent parallel rails, conductive brushes of the robot will complete the circuit. For example, a first one of the parallel rails 122 may have a positive polarity while an adjacent one of the parallel rails 122 may have a negative polarity.

Rails 122, 124 may include a double u-channel or profiled track having an upper surface 128, outer surfaces 130, inner surfaces 132 and drive surfaces 136a, 136b (collectively “drive surfaces 136”). As a result, two robots may traverse a single rail 122, 124, thereby increasing the number of robots that can drive on grid 126 at any given time. In other words, when a first robot is supported on drive surface 136a, the first robot may pass a second robot supported by drive surface 136b.

Storage structure 14 further includes one or more fluid supply systems 138. In some embodiments, at least one of the vertical members 116, horizontal members 118, horizontal members 120 or rails 122, 124 define or carry one or more fluid supply lines that transport a fluid such as water; a fertilizer fluid such as an aeoroponic solution, a hydroponic solution and/or an aquaponic solution; compressed air; nutrient gases such as CO₂, nitrogen, phosphorous, potassium, calcium, sulfur, magnesium etc. or any other growth media (all of which are hereinafter collectively referred to as “a fluid”) to the robots 200 for servicing the crops.

As will be discussed in more detail hereinafter, robot 200 may include one or more couplers 210 (FIGS. 5 and 6) for selectively accessing fluid from the external supply system 138 and one or more spraying mechanism for subsequently delivering the fluid to the crops. Fluid supply system 138 thus eliminates the need for the containers 110 and/or the storage structure 14 to include expensive built-in servicing means. The ability of the coupler to access fluid from the external fluid supply system 138 also eliminates the need for the robots 200 to be permanently connected to a fluid source via a hose (which would be difficult, if not impossible, to prevent each of the hoses from tangling as the robots traverse the grid), or the need for the robots to carry a large fluid tank (which would be prohibitively large for the robots to carry onboard while traversing the grid without modifying the robot to include a much larger body which, in turn, would require significantly reducing the number of robots that could traverse grid 126 at a single time). Nevertheless, in other embodiments, fluid supply system 138 may be integrated into storage structure 14 and/or containers 110 and include an array of nozzles for spraying fluid directly onto the crops.

Fluid supply system 138 includes a fluid source S and a supply line 140. Fluid source S may be a tank, a rain water harvesting system, a water line of IVS 12 or any other reservoir configured to supply fluid to supply line 140. Supply line 140 may include a series of channels 142, conduits 144 and ports 146. Channels 142 may extend along an entire length of the rails and are preferably embedded within a lower portion of the u-channel, thereby allowing the channel to extend continuously in a longitudinal direction of a respective rail without interruption at the intersections of rails 122 and rails 124. Alternatively, channels 142 may be isolated from one another. A plurality of conduits 144 extend between channel 142 and a port 146 located at a surface of the rail. In a preferred embodiment, at least one of rails 122, 124 that surrounds each one of grid spaces 127 has a port 146. Grid 126 is thus capable of supplying fluid to robot 200 irrespective of the location of the robot on the grid. Although FIG. 3A illustrates a single fluid supply system 138 extending within rail 122, 124, it will be appreciated that the rails may include a plurality of independent and discrete fluid supply systems 138 configured to deliver different fluids types to robot 200.

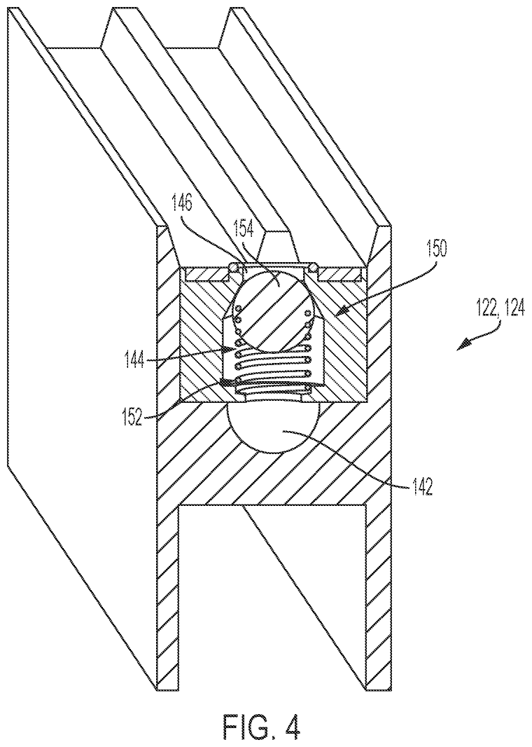

Referring to FIG. 4, a plurality of valves 150 may be disposed within the supply lines 140. Each valve 150 is transitionable between a closed condition in which the fluid is contained within supply line 140 and an open condition in which the supply line is in fluid communication with the environment such that fluid may be accessed to the robots. Valve 150 may include a biasing member 152, such as a spring, and a plug 154 coupled to the spring to seal port 146. When spring 152 is in a neutral or unbiased condition, the spring biases the plug into the port 146, which seals the fluid within supply line 140. Alternative valves may be used to seal the fluid within each of the supply systems. For example, the valve may be constructed as any passively or actively actuated valve capable of being transitioned between a closed condition and an open condition by one or more of the remote processors 18 and/or one of the robots 200.

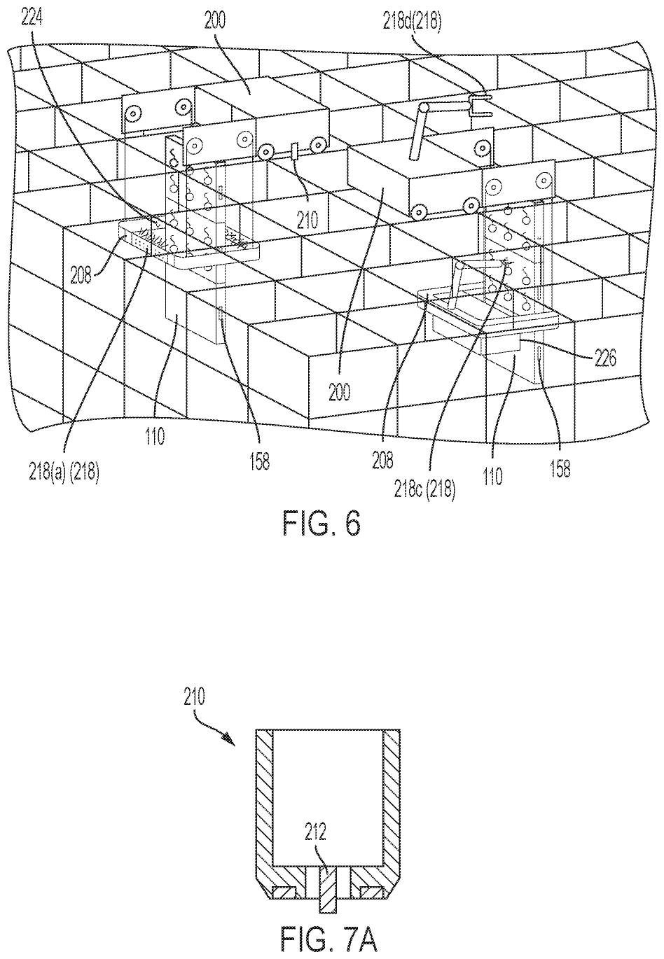

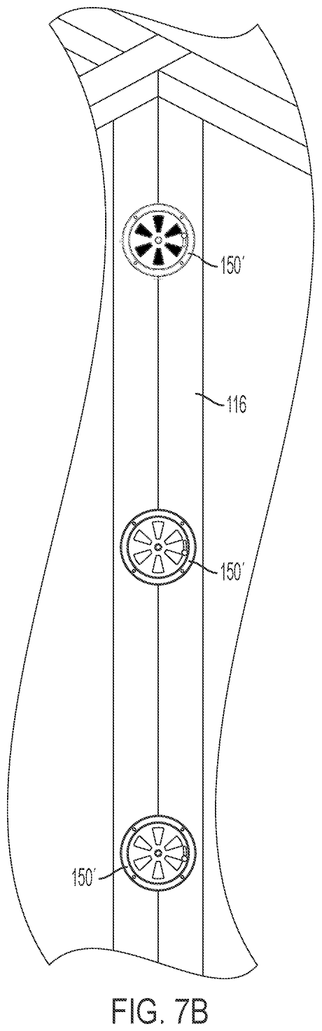

While supply line 140 is primarily described and illustrated herein as extending through the rails 122, 124 of grid 126, the supply line may alternatively extend at least partially through channels of vertical members 116, horizontal members 118 or horizontal members 120, or be attached to or otherwise coupled to an external surface of the rails and/or storage structure 14, or suspended above the grid. In one example, as shown in FIG. 7B, a series of valves 150′ may be positioned along a length of vertical members 116 and arranged to regulate fluid flow from a supply line 140 extending through the vertical members. The valves 150′ may include a series of perforations that selectively open and close via wireless signals or by actuation from robot 200. For example, the valves 150′ may be opened/closed in response to signals generated from processor 18, or in response to robot 200 actuating: (1) an actuator on the surface of grid 126 to simultaneously open/close each of the valves along vertical member 116; or (2) an actuator disposed on the valve itself to open/close only that valve. FIG. 7B is an illustrative example of a situation in which the actuator of uppermost valve 150′ has been activated and the perforations of the valve have been opened.

When containers 110 are formed as bins, as shown in FIG. 5, the containers are configured to hold or suspend a crop and a substrate such as soil, peat, a growth medium and/or a membrane such as coconut coir, perlite, organic-polymer composites, rockwool, etc. inside of the container. The bins are preferably molded from of a transparent material such as plexiglass, tempered glass, polycarbonate, or plastic thus allowing light to penetrate the transparent material and to reach the crops.

The bins include engagement features which aid robot 200 in grasping and lifting the bin from storage structure 14. The engagement feature may be, for example, a rim 156 formed at a top end of the bin or a recess formed in the sidewall of the bin. The top end of the bin may be open, or openable, to facilitate the insertion of a substrate into the bin prior to placing the bin within storage system 14. The bottom wall of the bin is preferably designed to nest within or against the rim 156 of a bin located beneath that bin. Therefore, when the bins are arranged in stacks 112, each bin will nest within the bin beneath it and the stacked bins will be prevented from moving laterally relative to one another. Consequently, storage structure 14 need not include any, or can include very few, vertical support member 116, thereby reducing the manufacturing cost of storage structure 14 and the speed in which the storage structure can be installed within IVS 12.

The bins are also preferably designed to allow fluid (including mists and gasses) to enter an interior of the partially enclosed container to provide the crops therein with sufficient nutrients to grow to maturity. For example, as is shown in FIG. 5, the bins may have one or more at open sides 160 (lateral, top, or bottom) through which fluid may be supplied to the crops. In another example, one or more of the sides may be configured to open and close, for example, via a sliding door. In this manner, when robot 200 is tasked with supplying fluid or otherwise servicing the crops in the bin, the door may be slid to its open position. After the crop has been serviced, the door may then be returned to its closed position to provide the crop with greater protection and/or to maintain a particular environment. In yet other embodiment, the bins have one or more apertures that allow fluids to enter the bin and/or a perforated pattern that permits fluid, such as gas, to reach the crops. The apertures may, in some instances, include a valve or another mechanism that controls the ability of a fluid to enter the bin.

When containers 110 are designed as a growing wall component, as shown in FIG. 6, the growing wall components are preferably formed from or otherwise include a substrate that encourages vines of the crop to grow on a surface of the component. The growing wall components may share some characteristics with the bins. For example, the bottom end of one of the growing wall components may be sized and shaped to nest against or within a top surface of another growing wall component such that that the growing wall components may be stacked on top of one another to form a larger growing wall without space separating each of the components in a vertical direction. Furthermore, each of the growing walls may have a rim 156 or opposing recesses 158 to assist robot 200 in retrieving one or more of the components from the storage structure 14.

Turning now to robot(s) 200 and, with reference to FIGS. 5 and 6, the robots include a vehicle body 202, a mobility assembly 204 and a plate 208 that is extendable and retractable in a vertical direction relative to the vehicle body. In some aspects, vehicle body 202 and/or plate 208 includes one or more service effectors for servicing the crops. A non-exhaustive list of service effectors include nozzles 218a for spraying or misting the crops with one or more liquids; hoses 218b for blowing or removing (via a vacuum force) liquid or gas from the containers to regulate the types/amount of liquid or gas within the containers, or to regulate the temperature and/or humidity within the containers; a cutting device 218c such as pruners to trim vines or stalks of the crops to foster growth; a robotic arm equipped with a manipulator 218d to manipulate, grasp and/or harvest the crops; and a valve actuator 218e to actuate valves located underneath grid 126 such as valves 150′ (these tools, and any other tool, designed to perform any farming task that at least in part assists in the cultivation, control, maintenance and/or harvesting of a crop may be referred to as “a service effector 218”). Valve actuator 218e may be any mechanical, magnetic, or electromechanical device configured to transition a valve between closed and open conditions. In other aspects, the plate does not include any service effectors 218. Instead, the plate 208 is used primarily for digging/reshuffling containers. Robots 200 without any service effectors are therefore sometimes referred to herein as digging robots. On the other hand, robots 200 including one or more service effectors 218 (whether coupled to the body 202 of the robot or to the extendable plate 208 of the robot) are sometimes referred to herein as service robots.

Each robot 200 also has a communication interface to send and receive data between the robot and remote computer 18. The data may include information obtained from onboard sensors regarding the crops (e.g., the health or maturity status), information obtained from a positioning sensor regarding the position of the robot relative to grid 126, or IVS 12 in general, to enable the remote computer to ascertain the relative position of the robot and to control movement of the robot about the grid or about the IVS, or information regarding required or preferred system maintenance.

Mobility assembly 204 includes a plurality of wheels that guide movement of vehicle body 202 along rails 122, 124 and about grid 126 to position robot 200 directly above (or adjacent to) the container(s) securing the crop that the robot is tasked with digging and/or servicing. Mobility assembly 204 may include a plurality of wheels, a motor and one or more transmissions (belts or linkages) operably coupling each one of the wheels to the motor. Each one of the wheels may be located at or adjacent to a corner of vehicle body 202. The orientation of each wheels is controlled by the motor and transmission. More specifically, the transmission couples the motor to each one of wheels such that rotation of the motor simultaneously rotates/pivots the orientation of each one of the wheels between a first orientation in which all of the wheels are oriented, for example, along rail 122, and a second orientation in which all of the wheels are aligned with rail 124 (e.g., 90 degrees). The wheels may include a direct drive (not shown) or quasi-direct drive (not shown) actuator within a hub with a magnetic encoder, a hub motor (not shown) and a gear drive actuator (not shown) or a belt drive actuator (not shown) to rotate the wheels and propel the robot in a direction in which the wheels are oriented. In this manner, mobility assembly 204 can be used to guide movement of vehicle body 202 in two directions, for example, along rails 122 (e.g., X-direction) and along rails 124 (e.g., Y-direction).

In situations in which service robot 200 includes a service effector 218 in the form of one or more nozzles 218a or one or more hoses 218b, the service robot also includes a coupler 210 to access a fluid supply from fluid supply system 138. Coupler 210 is in selective fluid communication with nozzles 218a or hoses 218b, via one or more bypass valves, and arranged to engage (mate) and disengage the valve 150 of storage structure 14 to access its external fluid supply. In one non-limiting aspect, coupler 210 is preferably extendable from a position within the sidewall of vehicle body 202 to a position that is at least partially outside of the sidewall of the vehicle body to allow the coupler to selectively engage and valve 150. With additional reference to FIG. 7A, the mating end of coupler 210 may include a valve transitioning device 212 for transitioning valve 150 between the closed and open conditions. Valve transitioning device 212 may be, for example, a mechanical member adapted to push plug 154 into conduit 144 (away from port 146), or any other device configured to electrically, magnetically, mechanically or otherwise transition valve 150, or another valve, between the closed and open conditions.

Regardless of whether or not plate 208 includes a service effector 218, the plate is coupled to body 202 by a support device such as pair of arms 216. Plate 208 is coupled to the pair of arms 216 by cables 220 which are, in turn, connected to a winding mechanism disposed in the arms such as a spool, hoist, or winch. Cables 220 can thus be wound and unwound or spooled into or out from support arms 216 to adjust the height of the plate 208 in the z-direction.

The plate 208 has an upper surface, a lower surface and an aperture 222 extending through the upper and lower surfaces. The perimeter of plate 208 may fully enclose aperture 222 such that the plate has four sides surrounding the aperture. On the other hand, plate 208 may have a single lateral side, two lateral sides, or three lateral sides to partially surround aperture 222. Preferably, aperture 222 is slightly larger than the outer perimeter of containers 110 such that plate 208 can slide about a stack 112 of the containers and to service a particular crop and/or retrieve a particular container. In this regard, as plate 208 is lowered along a stack 112 of containers 110, the stack of containers will automatically guide and align the plate relative to the containers in a lateral direction.

The digging robots and the servicing robots may use plate 208 to reshuffle containers 110 within storage structure 14 to reposition the crops in different environmental conditions as needed or to completely retrieve the containers from the storage structure for exterior processing of the crops. To retrieve containers 110, extendable plate 208 may include latches or hooks 224 adapted to engage with rim 156, recesses 158 and/or the sides of the container 110. For example, plate 208 may include sliding or pivotable hooks 224 that are driven into engagement with a container 110 by a suitable drive mechanism housed within plate 208, which may be powered and controlled by signals carried through cables 220, through a separate control cable (not shown), or wirelessly. To remove a container 110 from a stack 112, mobility assembly 204 positions digging or service robot 200 in the X and Y directions to position plate 208 above the stack in which the desired container is located. Plate 208 is then lowered around each of the containers 110 of stack 112, as shown in FIGS. 5 and 6 until the plate is at a desired depth (an encoder may be coupled to the spool or winding mechanism to accurately measure the depth or the distance that plate has traveled in the z-direction). After the plate has been positioned at a proper vertical location, the sliding or pivotable hooks 224 are driven into engagement with the engagement feature of container 110 to secure the container to plate 208 before cables 220 are spooled or wound to extract the container above grid 126. In this way, robots 200 can transport container 110 to another location.

The spool or winding mechanism may also include a torque sensor, a load cell or a similar device to measure the weight of one or more containers 110 supported by plate 208. As a result, processor 18 can autonomously determine the weight of the crops within a container that is secured by hoist plate 208. Similarly, the sensors may be used to ensure that robot 200 does not attempt to lift one or more containers with a total load greater than it can handle.

Referring to FIG. 6, hooks 224 may also be configured to secure one or more, smaller, retrieval bins 226 to plate 208. In this manner, retrieval bin 226 may be lowered and raised about a stack of containers, along with plate 208, as the robotic arm and manipulator 218d harvest (e.g., pick) one or more crops and place them directly into the retrieval bin. In this manner, crops can be extracted from storage structure 14 and inspected in more detail without having to extract the entire containers 110 of crops.

Plate 208 may include any one or more of the above-mentioned service effectors 218 (or others) or any combination of the foregoing. With specific reference to FIG. 5, when plate 208 includes a plurality of nozzles 218a, the nozzles may be situated about the plate in any pattern. For example, the nozzles 218a may be formed on the interior of the plate (directed toward aperture 222 and the stack 112 of containers 110 which the plate surrounds) and/or about the exterior of the plate (directed away from the aperture). In this regard, plate 208 can simultaneously spray crops held by containers 110 located in five different stacks 112.

In some embodiments, a sensor such as a camera, depth imager, or similar device may be provided on plate 208 to assist in aligning the plate relative to the containers 110 to aid in the accurate performance of the service. In addition to improving alignment, the camera can also continuously capture images of the crops as plate 208 is raised/lowered about the stacks 112 of containers 110. These images may then be transmitted via network channels 20 to remote processor 18 to monitor crop maturation and health and, if necessary, to adjust the servicing schedule (including the selection of proper services and/or the frequency of services) to optimize crop growth.

While the service effectors 218 are primarily described herein as being provided on the extendable and retractable plate 208 to directly or indirectly service the crops accommodated within storage structure 14, it will be understood that any one of the service effectors may be spaced from the plate. Service effectors 218 may be coupled to the body 202 of service robot 200. As shown in FIGS. 5 and 6, for example, a cutting device 218c and/or a robot arm and manipulator tool 218d may be coupled to the body 202 of robot 200 to prune or pick crops after containers 110 have been retrieved from storage structure 14.

Use of robot 200 to perform services, such as cultivating and harvesting crops, will now be described. When the service task requires dispensing a fluid from service plate 208 to the crops, robot 200 may be autonomously moved about grid 126, under the control of remote processor 18, to position the plate above a desired stack 112 of containers 110 (aligned in the Z direction), or adjacent to the desired stack of containers. The coupler 210 is then selectively mated with valve 150, associated with a desired fluid supply system 138, to transition the valve to its open condition, thereby allowing fluid to flow from the fluid supply system to robot 200. More specifically, coupler 210 may be engaged with valve 150 such that mechanical device 212 compresses plug 154 into conduit 144 (away from the upper surface 128 of rails 122, 124) to transition the valve from the closed condition to the open condition, thereby allowing fluid to flow around the plug and into the coupler. With fluid supply system 138 in communication with robot 200, the robot may immediately use the fluid to service the crops

To deliver the fluid to the crops, plate 208 is lowered by un-spooling cables 220 to allow each of the containers in the desired stack to pass through the aperture 222 of the plate as the plate is lowered around the stack 112 of containers. If all of the crops within a particular stack are to be watered for a period of time, for example 20 seconds, plate 208 can consistently supply a fluid to the stack as the plate is lowered and/or raised about the stack. On the other hand, if only certain containers 110 within that particular stack and/or an adjacent stack are scheduled to receive a particular fluid, certain nozzles provided within the extendable plate 208 can be toggled on/off based upon the location of plate 208 relative to the stack of containers. If robot 200 is tasked with servicing the crops with more than one fluid, it will be appreciated that the coupler can simply connect to the valve of a different fluid supply system 138 (containing the other desired fluid) and the above explained process can be repeated until each of the desired fluids have been delivered. Or, in situations where robot 200 includes multiple couplers 210, the robot may simultaneously service the crops with two or more fluids.

Robot 200 can alternatively utilize valve actuator 218e to selectively control direct fluid flow from fluid supply system 138 to the crops. For example, valve actuator 218e may activate an actuator on a surface of grid 126 to cause a series of valve(s) 150′ disposed along one or more vertical members 116 to open and to spray the crops before deactivating the actuator to close the valves, thereby stopping fluid flow. On the other hand, plate 208 may selectively open and close certain individual valves 150′ to directly spray select crops by lowering the plate a location adjacent an actuator of the valve and actuating the actuator. In this manner, storage structure 14 need not be entirely outfitted with wireless valves and other expensive components required to wirelessly open/close the valves.

If a pruning service is to be provided, service plate 208 is simply lowered and/or raised, as described above, to a desired height that allows a cutting device 218c (e.g., pruning shears) to trim the crop. When a crop has grown to maturity and is ready to be harvested, the crop may either be harvested within storage structure 14 or on a surface of the grid. As shown in FIG. 6, to achieve the former, plate 208 (and in some instances retrieval bin 226) may be lowered within storage structure 14, as explained above, to a location adjacent the crop to be harvested. Once at the desire location, cutting device 218c may cut and/or manipulator tool 218d may pick a crop from container 110 and place the crop directly into retrieval bin 226 before the harvested crops are brought to a surface of grid 126 for further processing.

On the other hand, if the crops are to be harvested on the surface of the grid, container 110 must first be extracted from the storage structure. Containers 110 of crops may be extracted from storage structure 14 by lowering plate 208 to a desired depth before activating the hooks 224 and driving the hooks into engagement with the engagement features (e.g., the rim 156 or the recesses 158) of to the container to secure the container to the plate. Cables 220 may then be spooled to extract the container(s) 110 from storage structure 14. Extraction can be performed one container at a time (top-down) or in a single lift in which multiple containers are extracted at once. After the desired container(s) 110 have been extracted from storage structure 14, additional services such as pruning and/or harvesting of the crop can be performed on grid 126. Robotic farming system 10 is thus configured to service vertically arranged and densely packed crops without needing to consistently retrieve containers 110 from the storage structure 14 and without utilizing expensive containers and/or storage structures having built-in servicing means.

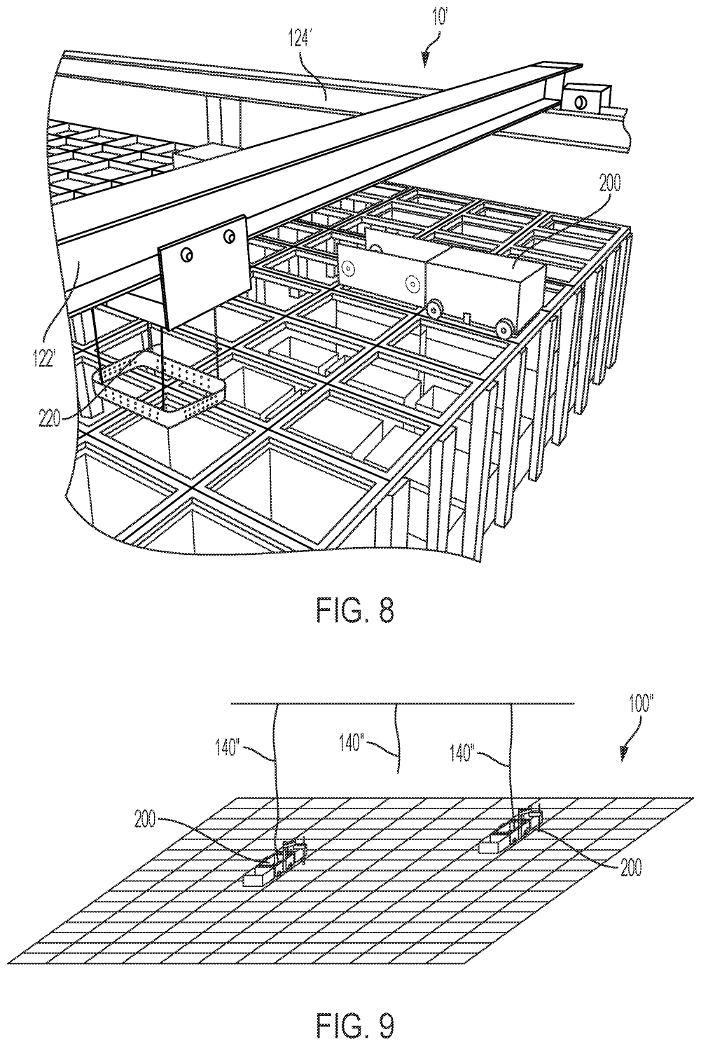

FIG. 8 is a perspective view of a modified robotic farming system 10′. Modified robotic farming system 10′ includes all of the above described features of system 10 and the additional features described hereinafter. For example, additional rails 122′, 124′ may extend above the grid 126 and alone, or in combination with additional support members, form a gantry frame that supports one or more extendable plates 208′ including any one or more service effectors 218′. The gantry frame is designed to move extendable plate 208′ in the X and Y directions to freely position the extendable plate above any one of the stacks 112 of containers 110. Cables 220′ couple extendable plate 208′ to the gantry frame and allow the extendable plate to move in the Z direction relative to the gantry frame in the same manner that plate 208 is moved relative support arms 216. As a result, extendable plate 208′ can service the crops and/or reshuffle and extract containers from the storage structure in a manner substantially similar to that explained above with respect to robotic farming system 10.

FIG. 9 is a perspective view of yet another robotic farming system 10″. Robotic farming system 10″ includes all of the above described features of robotic system 10 and the additional features described hereinafter. Service robot 200 may be positioned at a station on grid 126 (e.g., so as to not move or so as to only move within a specific area of the grid) and permanently or selectively coupled to supply lines 140″ that hang from a structure above the grid, for example, the ceiling of IVS 12 or otherwise extend toward the surface of the grid to provide the service robots with access to an external fluid supply. In this regard, the service robots 200 can deliver fluid to the crops in a manner substantially similar to that explained above with respect to robotic farming system 10. In some embodiments, supply lines 140″ may be retracted, for example, via a drag chain cable carrier, a cable reel retractor or similar device to manage cable slack in the supply lines. Supply lines 140″ may additionally include a power cord, or other mechanism, to supply a voltage to the service robot allowing the robot to provide other services to the crops.

While the above IVS 12 is described as a farming system for cultivating and harvesting plants, it is contemplated that similar systems could be used for a variety of other applications including, but not limited to, farming animals, preparing meals in densely packed “dark kitchens” and manufacturing.

For example, instead of holding crops, the bins may alternatively be used to hold and raise animals including chickens or fish, or any other animal typically raised on a farm. Those bins, and/or other bins, may additionally hold water and/or food. The servicing robots 200 may use its service effectors 218 to access the water and/or food and distribute it to the animals. A servicing effector such as a manipulator tool may also be used to retrieve animal by products such as eggs from the containers or dispose of materials such as animal waste or old food from the containers. Multiple different manipulator tools such as pneumatic or electrically actuated tools (finger grippers, compliant finger grippers, suction cups, scissors, trimmers, clippers, rakes, shovels, weeders, cultivators, trowels, forks, compost scoops, dibbers, twist cultivators, ergo hoes, secateurs, transplants, misters, etc.) may be provided on the robot to handle different items and perform different service tasks (e.g., the raising of the animals).

The term “dark kitchen” means a system that stores ready-to-eat food items and/or ingredients such as vegetables, fruits, meats, grains, oats, pastas, sauces, seasoning, condiments, etc. which can subsequently be prepared into a meal (collectively “food”) in containers 110. Depending on the food item, containers 110 may include a frozen, refrigerated and/or heated buffet table (or equivalent) to prevent the food items from perishing or getting cold. Consumers may place one or more orders, for example, at a kiosk or through a mobile app. When an order is received, the servicing robots may traverse grid 126 and use its manipulator 218d to retrieve a meal or ingredients for making the meal. In some instances, servicing robots 200 may deliver the ingredients to another location of the IVS where the ingredients are prepared into a completed meal by an operator or another robot. In other instances, the servicing robot that retrieved the ingredients may further include an onboard grill, oven or mixer to prepare the ingredients into a completed order.

The above-described dark kitchens are thus configured to densely store more ingredients and food stock than a typical kitchen. In this manner, the dark kitchens may hold a greater amount of food and a greater variety of food. Such storage is advantageous in densely populated urban areas to offer expanded menus and/or its consumers to customize meals not offered by limited menus. Food retrieval and/or meal preparation could also be efficiently centralized and delivered without having to implement several small kitchens and/or grab and go restaurants.

It is further contemplated that a similar IVS could be useful in manufacturing facilities. Parts could be densely stored in containers 110, allowing a manufacturing plant to densely store a greater number of parts and a greater variety of parts than a traditional manufacturing plant. Servicing robots 200 can traverse grid 126 and extract entire containers 110 of parts, or individual parts from the containers, and transport them to an area of the facility for assembly. Alternatively, the servicing robots could assemble the parts during transit or while idling in a flexible, reprogrammable assembly-line type process.

To summarize the forgoing, a mobile robot for cultivating crops secured to or housed within a container includes, a body, a wheel assembly having a plurality of wheels and an actuator configured to move the body along a set of parallel rails, and a plate extendable in a vertical direction equipped with a service effector for servicing the crops; and/or
the plate may have at least three sides collectively defining an aperture, and the three sides may be sized and arranged to slide along corresponding sides of the container such that the container is configured to pass through the aperture of the plate when the plate is lowered in the vertical direction; and/or
the mobile robot may further include a coupler having a mating end to access a fluid supply from an external fluid supply source; and/or
the service effector may include a first nozzle in communication with the coupler; and/or
the service effector may further include a second nozzle in communication with the coupler and the first nozzle may be provided on a first one of the at least three sides of the plate and the second nozzle may be provided on a second one of the at least three sides of the plate different than the first one of the at least three sides; and/or
the plate may include a latching device configured to engage and secure the container to the plate.

In another aspect, a robotic farming system includes: a storage structure arranged to accommodate crops in a plurality of horizontal rows arranged in a vertical direction, the storage structure including a first set of parallel rails; and a mobile robot including a body, a mobility assembly to move the body along the first set of parallel rails, and a service effector for servicing the crops; and/or
the robotic farming system may further include a second set of parallel rails extending substantially perpendicular to the first set of parallel rails such that the first and second set of parallel rails form a grid having a plurality of grid spaces; and/or
the robotic farming system may further include a plurality of bins configured to accommodate the crops, the plurality of bins may be stackable upon one another to form a plurality of vertical stacks, and each vertical stack may be arranged underneath a respective one of the grid spaces; and/or
at least one of the plurality of bins may be formed from a transparent material; and/or
at least one of the plurality of bins may have an aperture, a perforation, or an open sidewall; and/or
the robotic farming system may further include a plurality of containers, whereby at least one of the containers may be formed as a growing wall component; and/or
the robotic farming system may further include at least one supply line and a plurality of valves, and each of the valves may have a closed condition in which the at least one supply line is in isolation from an outside environment and an open condition in which the at least one supply line is in communication with the outside environment; and/or
the at least one supply line may include a first supply line and a second supply line; and/or
the mobile robot may further include a coupler with a mating end to access a fluid supply from the at least one supply line; and/or
the service effector may include at least one nozzle in communication with the coupler; and/or
the robot may further include a plate extendable in a vertical direction relative to the body, the plate may have at least three sides collectively defining an aperture, whereby the three sides may be sized and arranged to slide along corresponding sides of the container such that the container is configured to pass through the aperture of the plate when the plate is lowered in the vertical direction; and/or
the service effector may include at least one nozzle provided on the plate; and/or
the service effector may include a robotic arm having a manipulator tool and/or a pruning tool coupled to the plate; and/or
the service effector may include a robotic arm having a manipulator tool and/or a pruning tool coupled to the body and spaced away from the plate.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A mobile robot for cultivating crops secured to or housed within a container, the mobile robot comprising:
a body;
a wheel assembly coupled to the body, the wheel assembly including a plurality of wheels and an actuator configured to move the body along a set of parallel rails; and
a plate extendable in a vertical direction relative to the body, the plate having a service effector for servicing the crops.

2. The mobile robot of claim 1, wherein the plate has at least three sides collectively defining an aperture, and wherein the three sides are sized and arranged to slide along corresponding sides of the container such that the container is configured to pass through the aperture of the plate when the plate is lowered in the vertical direction.

3. The mobile robot of claim 2, further comprising a coupler having a mating end to access a fluid supply from an external fluid supply source.

4. The mobile robot of claim 3, wherein the service effector comprises a first nozzle in communication with the coupler.

5. The mobile robot of claim 4, wherein the service effector further comprises a second nozzle in communication with the coupler and wherein the first nozzle is provided on a first one of the at least three sides of the plate and the second nozzle is provided on a second one of the at least three sides of the plate different than the first one of the at least three sides.

6. The mobile robot of claim 1, wherein the plate comprises a latching device configured to engage and secure the container to the plate.

7. A robotic farming system, comprising:
a storage structure arranged to accommodate crops in a plurality of horizontal rows arranged in a vertical direction, the storage structure including a first set of parallel rails; and
a mobile robot comprising:
a body;
a mobility assembly to move the body along the first set of parallel rails; and
a service effector for servicing the crops.

8. The system of claim 7, wherein the storage structure further comprises a second set of parallel rails extending substantially perpendicular to the first set of parallel rails, the first and second set of parallel rails forming a grid having a plurality of grid spaces.

9. The system of claim 8, further comprising a plurality of bins configured to accommodate the crops, the plurality of bins being stackable upon one another to form a plurality of vertical stacks, each vertical stack arranged underneath a respective one of the grid spaces.

10. The system of claim 9, wherein at least one of the plurality of bins is formed from a transparent material.

11. The system of claim 9, wherein at least one of the plurality of bins has an aperture, a perforation, or an open sidewall.

12. The system of claim 7, further comprising a plurality of containers, wherein at least one of the containers is formed as a growing wall component.

13. The system of claim 7, further comprising at least one supply line and a plurality of valves, each of the valves having a closed condition in which the at least one supply line is in isolation from an outside environment and an open condition in which the at least one supply line is in communication with the outside environment.

14. The system of claim 13, wherein the at least one supply line includes a first supply line and a second supply line.

15. The system of claim 13, wherein the mobile robot further comprises a coupler with a mating end to access a fluid supply from the at least one supply line.

16. The system of claim 15, wherein the service effector comprises at least one nozzle in communication with the coupler.

17. The system of claim 7, wherein the robot further comprises a plate extendable in a vertical direction relative to the body, the plate having at least three sides collectively defining an aperture, wherein the three sides are sized and arranged to slide along corresponding sides of the container such that the container is configured to pass through the aperture of the plate when the plate is lowered in the vertical direction.

18. The system of claim 17, wherein the service effector comprises at least one nozzle provided on the plate.

19. The system of claim 17, wherein the service effector comprises a robotic arm having a manipulator tool and/or a pruning tool coupled to the plate.

20. The mobile robot of claim 17, wherein the service effector comprises a robotic arm having a manipulator tool and/or a pruning tool coupled to the body and spaced away from the plate.
